(19) United States
(12) Patent Application Publication
(10) Pub. No.: US 2019/0305410 A1
(43) Pub. Date: Oct. 3, 2019

(54) RADIO-WAVE TRANSPARENT COVER AND METHOD FOR MANUFACTURING RADIO-WAVE TRANSPARENT COVER

(71) Applicant: TOYODA GOSEI CO., LTD., Kiyosu-shi (JP)

(72) Inventors: Seiya TOKUNAGA, Kiyosu-shi (JP); Hideto MAEDA, Kiyosu-shi (JP); Kimihiro IIMURA, Kiyosu-shi (JP)

(21) Appl. No.: 16/359,220

(22) Filed: Mar. 20, 2019

(30) Foreign Application Priority Data
Mar. 30, 2018 (JP) 2018-066802

(51) Int. Cl. H01Q 1/40; B29C 45/16; H01Q 1/42

(52) U.S. Cl. CPC H01Q 1/40; G01S 2013/9375; H01Q 1/42; B29C 45/1671

(57) ABSTRACT

A radio-wave transparent cover is configured to be arranged in a path of a radio wave in a radio wave radar device. The radio-wave transparent cover is made of a synthetic plastic molding product through which the radio wave passes. The molding product includes a first layer including a protrusion on a back side of the first layer and a second layer formed on the back side of the first layer. A back surface of the second layer includes gate marks formed when injection molding is performed. An area of the molding product for each one of the gate marks is less than or equal to sixteen square centimeters.

### BACKGROUND

The present invention relates to a radio-wave transparent cover arranged in the path of a radio wave in a radio wave radar device installed in, for example, an automobile and a method for manufacturing the radio-wave transparent cover.

Japanese Laid-Open Patent Publication No. 2009-88579 discloses a typical example of such a radio-wave transparent cover. The radio-wave transparent cover is made of a synthetic plastic molding product and includes a cover layer, a design layer that covers the rear surface of the cover layer, and a base layer that covers the rear surface of the design layer. The cover layer includes a first cover layer made of transparent polycarbonate and a black second cover layer that covers the rear surface of the first cover layer and is made of polycarbonate. The design layer is formed by vapor-depositing indium on the rear surface of the second cover layer. The base layer is made of a black AES plastic.

The rear surface of the second cover layer includes grooves. Portions that partition the grooves are partition walls. That is, partition walls having the shape of a rectangular plate protrude from the rear surface of the second cover layer such that a groove is located between adjacent ones of the partition walls. The partition walls are arranged at equal intervals in parallel to one another. When forming the base layer on the rear surface of the design layer, molten AES plastic is injected into a cavity from one gate of a fourth mold that forms the base layer so that each partition wall is bent by the flow pressure of the molten AES plastic. This forms each partition wall into an undercut shape in the thickness direction of the base layer. As a result, the base layer is rigidly engaged with the rear surface of the second cover layer with the design layer located in between.

### SUMMARY

There has been a need for the above-described radio-wave transparent cover to be reduced in thickness as much as possible. For example, when the thickness of the base layer is reduced, the protruding dimension of each partition wall also needs to be reduced in correspondence with the thickness of the base layer. However, when the protruding dimension of each partition wall is reduced, the partition wall will hardly be bent by only the flow pressure of the molten AES plastic injected from one gate. This prevents each partition wall from having an undercut shape in the thickness direction of the base layer. Thus, the adhesiveness of the base layer (second layer) on the rear surface of the second cover layer (first layer) with the design layer located in between is not ensured.

It is an object of the present invention to provide a radio-wave transparent cover and a method for manufacturing a radio-wave transparent cover capable of ensuring the adhesiveness of a second layer on a first layer even if the thickness of the second layer is reduced.

A radio-wave transparent cover that solves the above-described problem is configured to be arranged in a path of a radio wave in a radio wave radar device. The radio-wave transparent cover is made of a synthetic plastic molding product through which the radio wave passes. The molding product includes a first layer including a protrusion on a back side of the first layer and a second layer formed on the back side of the first layer. A back surface of the second layer includes gate marks formed when injection molding is performed. An area of the molding product for each one of the gate marks is less than or equal to sixteen square centimeters.

In a method for manufacturing a radio-wave transparent cover that solves the above-described problem, the radio-wave transparent cover is configured to be arranged in a path of a radio wave in a radio wave radar device. The radio-wave transparent cover is made of a synthetic plastic molding product through which the radio wave passes. The method includes a first layer forming step of forming a first layer including a protrusion on a back side of the first layer and a second layer forming step of forming a second layer on the back side of the first layer. In the second layer forming step, a molten synthetic plastic material is injected from gates into a cavity of a mold that forms the second layer such that an area of the molding product for each one of the gates is less than or equal to sixteen square centimeters.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a front view of a radio-wave transparent cover according to an embodiment;

FIG. 2 is a cross-sectional view taken along line 2-2 in FIG. 1;

FIG. 3 is a schematic cross-sectional view illustrating a step of manufacturing the radio-wave transparent cover;

FIG. 4 is a schematic cross-sectional view illustrating a step of manufacturing the radio-wave transparent cover;

FIG. 5 is a schematic cross-sectional view illustrating a step of manufacturing the radio-wave transparent cover;

FIG. 6 is a schematic cross-sectional view illustrating a step of manufacturing the radio-wave transparent cover;

FIG. 7 is a schematic diagram showing the inside of a cavity of a mold shown in FIG. 6; and

FIG. 8 is a schematic cross-sectional view illustrating a step of manufacturing the radio-wave transparent cover.

### DETAILED DESCRIPTION

A radio-wave transparent cover 11 according to an embodiment will now be described with reference to the drawings.

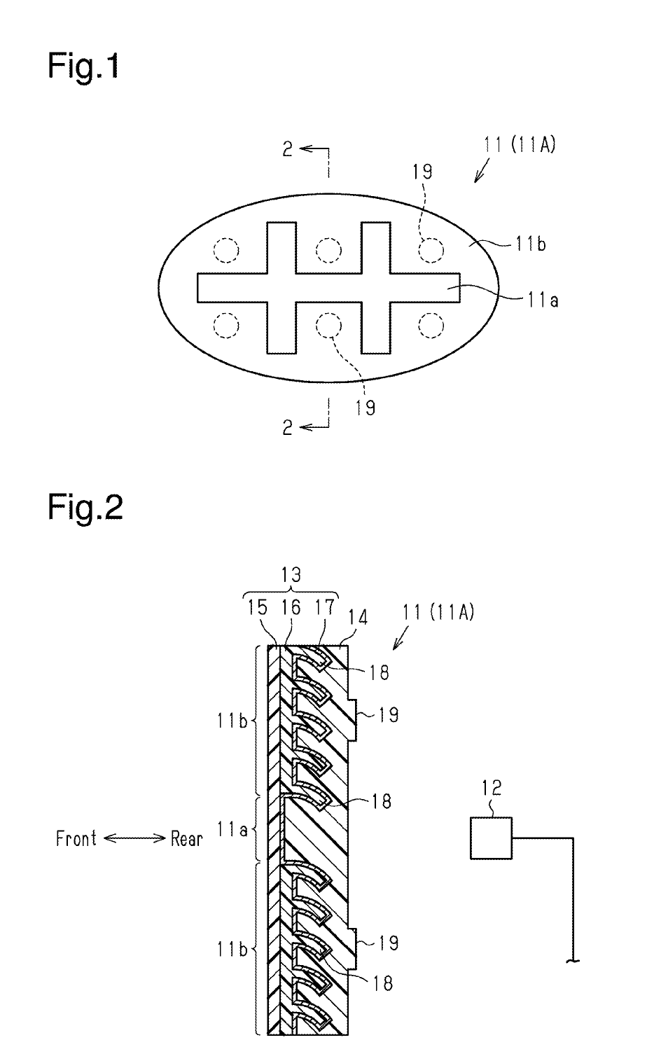

As shown in FIGS. 1 and 2, the radio-wave transparent cover 11 of the present embodiment is an emblem coupled to the opening of a front grille arranged on the front surface of a vehicle (not shown). The radio-wave transparent cover 11 is located on the front side of a radio-wave radar device 12 and arranged in the path of a radio wave (millimeter radar) in the radio-wave radar device 12, which is installed in the vehicle.

The radio-wave transparent cover 11 includes a synthetic plastic molding product 11A through which a radio wave passes. The molding product 11A (radio-wave transparent cover 11) includes a first layer 13 and a second layer 14 formed on the rear surface (back side) of the first layer 13. The first layer 13 includes a colorless, transparent first cover layer 15, a colored second cover layer 16 formed on the rear surface (back side) of the first cover layer 15, and a design layer 17 formed on the rear surface (back side) of the second cover layer 16.

Protrusions 18 are formed substantially entirely on the rear surface of the second cover layer 16 at equal intervals. Each protrusion 18 protrudes so as to be bent in the direction intersecting the thickness direction of the molding product 11A. The design layer 17 is formed along each protrusion 18. That is, the design layer 17 is formed in correspondence with the shape of the rear surface of the second cover layer 16, where recesses and projections are formed by the protrusions 18.

A part of the rear surface of the first cover layer 15 has a region on which the second cover layer 16 is not formed. This region corresponds to an emblem region 11a of the radio-wave transparent cover 11. A part of the rear surface of the first cover layer 15 has a region on which the second cover layer 16 is formed. This region corresponds to a background region 11b of the radio-wave transparent cover 11.

The first cover layer 15 can be made of, for example, polycarbonate or an acrylic plastic. When the first cover layer 15 is made of an acrylic plastic, it is preferred that a polymethyl methacrylate (PMMA) plastic, which is particularly excellent in wear resistance among acrylic plastics, be used. In the present embodiment, the first cover layer 15 is made of polycarbonate, which is a transparent plastic.

The second cover layer 16 is made of a material in which carbon black is mixed with polycarbonate. Thus, the second cover layer 16 is black. The design layer 17 is made of a radio wave transmissive metal (indium in the present embodiment) and formed by vapor-depositing indium on the part of the rear surface of the first cover layer 15 corresponding to the emblem region 11a and on the rear surface of the second cover layer 16.

The second layer 14 is made of a black AES plastic (acrylonitrile ethylene styrene copolymer) and covers the entire rear surface of the design layer 17. That is, the second layer 14 is formed through insert-molding (injection molding) so as to cover the entire rear surface of the first layer 13. The rear surface (back surface) of the second layer 14 includes multiple (six in the present embodiment) gate marks 19 that are formed when insert-molding is performed. In the front view of the molding product 11A, the area of each one of the gate marks 19 is less than or equal to sixteen square centimeters.

The method for manufacturing the radio-wave transparent cover 11 (molding product 11A) will now be described.

The radio-wave transparent cover 11 (molding product 11A) is manufactured through a first layer forming step of forming the first layer 13, which includes the protrusions 18 on the back side, and a second layer forming step of forming the second layer 14 on the back side of the first layer 13, which is formed in the first layer forming step.

First Layer Forming Step

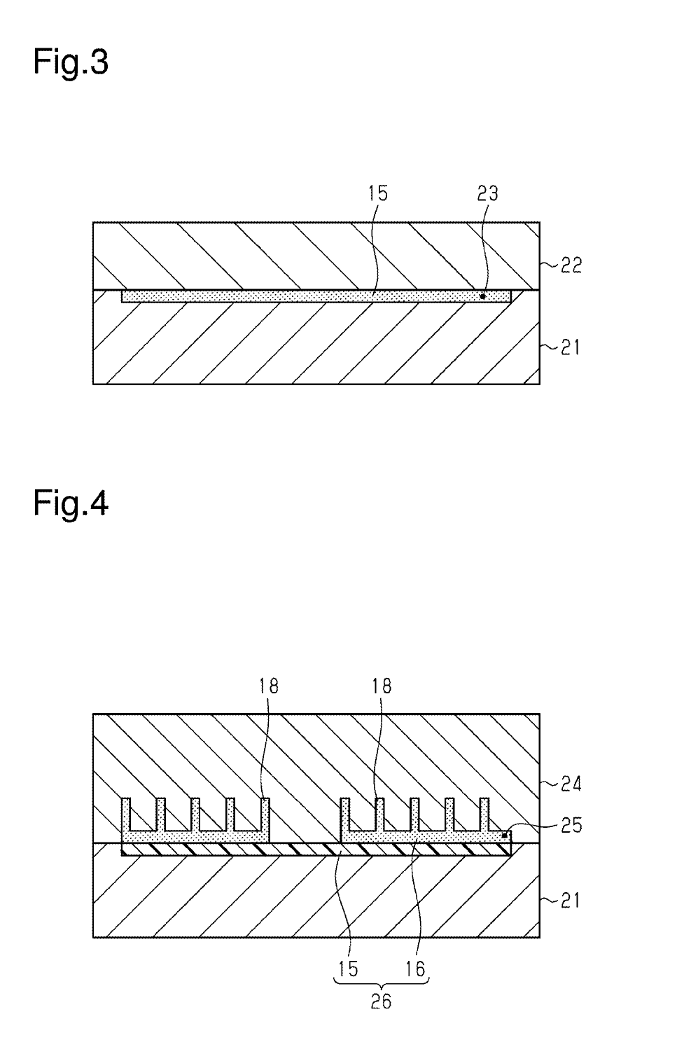

As shown in FIG. 3, in order to form the first layer 13, first, a first mold 21 that forms the front surface of the first cover layer 15 and a second mold 22 that forms the rear surface of the first cover layer 15 are closed. Then, molten polycarbonate is injected from gates (not shown) and fills a cavity 23 formed between the first mold 21 and the second mold 22. After the molten polycarbonate in the cavity 23 is cooled and solidified, the first cover layer 15 is formed in the cavity 23.

Subsequently, as shown in FIG. 4, the second mold 22 is replaced with a third mold 24 that forms the rear surface of the second cover layer 16. This forms a cavity 25 between the rear surface of the first cover layer 15, which remains in the first mold 21, and the mold surface of the third mold 24. Afterwards, the molten mixture material of molten polycarbonate and carbon black is injected from gates (not shown) and fills the cavity 25.

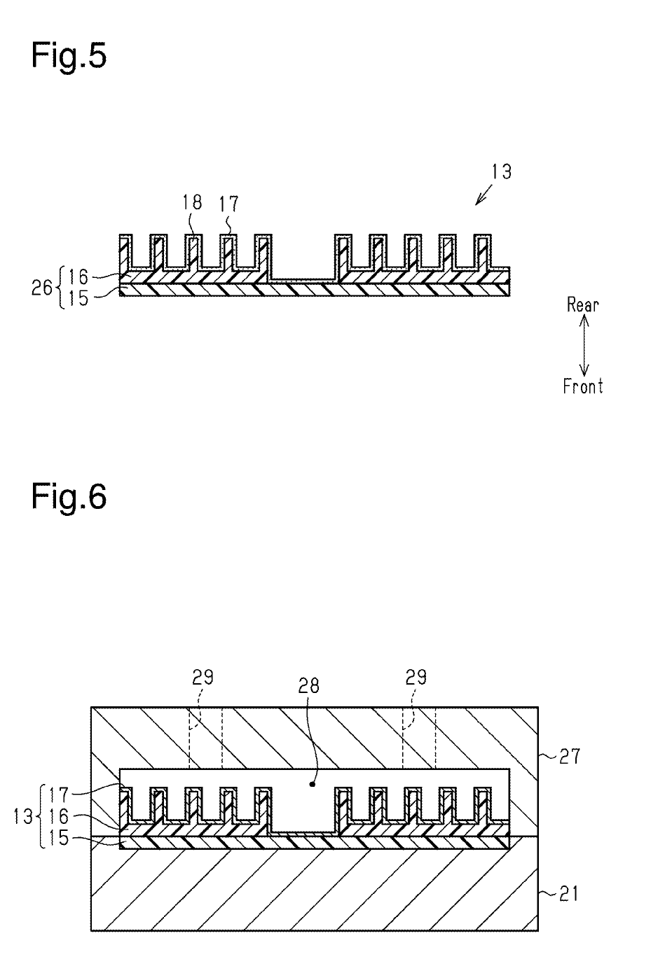

After the molten mixture material in the cavity 25 is cooled and solidified, an intermediate 26 in which the second cover layer 16 is formed on the rear surface of the first cover layer 15 is obtained. Subsequently, as shown in FIG. 5, the front surface and the side surface of the intermediate 26 are masked to each other and indium is vapor-deposited on the rear surface of the intermediate 26 to form the design layer 17. As a result, the first layer 13 is obtained.

Second Layer Forming Step

As shown in FIG. 6, in order to form the second layer 14, a fourth mold 27 is first prepared. The fourth mold 27 is a mold for forming the rear surface of the second layer 14. Then, the first mold 21 and the fourth mold 27 are closed with the first layer 13, which is obtained in the above-described first layer forming step, placed on the mold surface of the first mold 21. This forms a cavity 28 between the mold surface of the fourth mold 27 and the rear surface of the first layer 13 on the mold surface of the first mold 21.

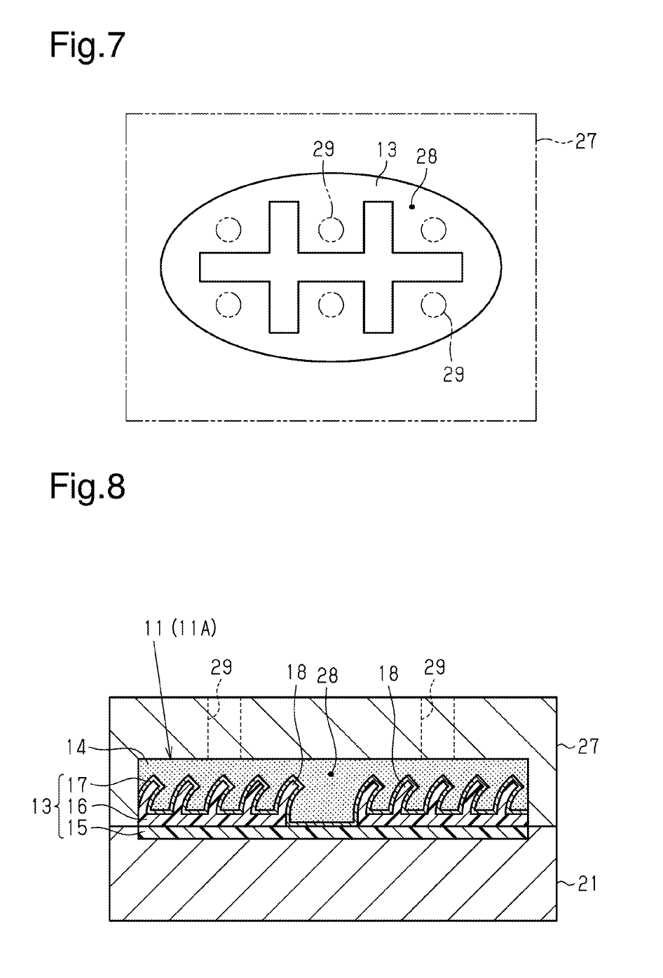

Subsequently, as shown in FIGS. 7 and 8, molten AES plastic (molten synthetic plastic materials) is injected from multiple (six in the present embodiment) gates 29 formed in the fourth mold 27 into the cavity 28 and fills the cavity 28. After the AES plastic in the cavity 28 is cooled and solidified, the radio-wave transparent cover 11 (molding product 11A) shown in FIG. 2 is obtained. In this case, six gate marks 19 are formed in the back surface of the radio-wave transparent cover 11 (molding product 11A), that is, the back surface of the second layer 14.

The six gates 29 in the fourth mold 27 are arranged such that the area of the molding product 11A for each one of the gates 29 is less than or equal to sixteen square centimeters. Thus, when molten AES plastic is injected from the six gates 29, which are formed in the fourth mold 27, into the cavity 28, each protrusion 18 of the second cover layer 16 sufficiently receives the flow pressure of the molten AES plastic. This ensures that the protrusions 18 of the second cover layer 16 are bent in the flow direction of the molten AES plastic even if the protruding dimension of the protrusion 18 is lowered to reduce the thickness of the second layer 14.

Thus, each protrusion 18 extends in the direction intersecting the thickness direction of the second layer 14 (vertical direction in FIG. 8). This forms each protrusion 18 into an undercut shape in the thickness direction of the second layer 14. Accordingly, since each protrusion 18 is rigidly engaged with the second layer 14 in the thickness direction of the second layer 14, the adhesiveness of the second layer 14 on the first layer 13 is ensured even if the thickness of the second layer 14 is reduced. That is, separation of the second layer 14 from the first layer 13 is effectively limited.

The embodiment described above in detail has the following advantages.

(1) In the radio-wave transparent cover 11 (molding product 11A), the back surface of the second layer 14 includes the six gate marks 19, which are formed when injection-molding is performed. The area of the molding product 11A for each one of the gate marks 19 is less than or equal to sixteen square centimeters. Even if the protruding dimension of each protrusion 18 of the first layer 13 is lowered to reduce the thickness of the second layer 14, this structure ensures that the protrusions 18 of the first layer 13 are bent by the flow pressure of molten AES plastic when the molten AES plastic is injected into the cavity 28 of the fourth mold 27, which forms the second layer 14, from the six gates 29 of the fourth mold 27. Thus, since each protrusion 18 has an undercut shape in the thickness direction of the second layer 14, the adhesiveness of the second layer 14 on the first layer 13 is ensured even if the thickness of the second layer 14 is reduced.

(2) In the method for manufacturing the radio-wave transparent cover 11 (molding product 11A), in the second layer forming step, molten AES plastic is injected from the six gates 29 into the cavity 28 of the fourth mold 27, which forms the second layer 14, such that the area of the molding product 11A for each one of the gates 29 is less than or equal to sixteen square centimeters. Thus, the temperature of the molten AES plastic is distributed uniformly in the cavity 28. This limits formation of sink marks (recesses) in the second layer 14 of the radio-wave transparent cover 11 (molding product 11A).

### MODIFICATIONS

It should be apparent to those skilled in the art that the present invention may be embodied in many other specific forms without departing from the spirit or scope of the invention. Particularly, it should be understood that the present invention may be embodied in the following forms.

The number of the gates 29 formed in the fourth mold 27 may be changed as long as the area of the molding product 11A for each one of the gates 29 is less than or equal to sixteen square centimeters.

In the radio-wave transparent cover 11, the design layer 17 may be omitted.

The radio-wave transparent cover 11 does not necessarily have to be a vehicle emblem. That is, the radio-wave transparent cover 11 may be, for example, a vehicle exterior panel or a component other than a vehicle.

Therefore, the present examples and embodiments are to be considered as illustrative and not restrictive and the invention is not to be limited to the details given herein, but may be modified within the scope and equivalence of the appended claims.

1. A radio-wave transparent cover configured to be arranged in a path of a radio wave in a radio wave radar device, the radio-wave transparent cover being made of a synthetic plastic molding product through which the radio wave passes, the molding product comprising:
a first layer including a protrusion on a back side of the first layer; and
a second layer formed on the back side of the first layer, wherein
a back surface of the second layer includes gate marks formed when injection molding is performed, and
an area of the molding product for each one of the gate marks is less than or equal to sixteen square centimeters.

2. A method for manufacturing a radio-wave transparent cover configured to be arranged in a path of a radio wave in a radio wave radar device, the radio-wave transparent cover being made of a synthetic plastic molding product through which the radio wave passes, the method comprising:
a first layer forming step of forming a first layer including a protrusion on a back side of the first layer; and
a second layer forming step of forming a second layer on the back side of the first layer, wherein
in the second layer forming step, a molten synthetic plastic material is injected from gates into a cavity of a mold that forms the second layer such that an area of the molding product for each one of the gates is less than or equal to sixteen square centimeters.
